(19) United States
(12) Patent Application Publication
(10) Pub. No.: US 2026/0330701 A1
(43) Pub. Date: Oct. 22, 2026

(54) ANALYSIS OF UNIDENTIFIED AERIAL PHENOMENA

(71) Applicant: ENIGMA LABS, LLC, New York, NY (US)

(72) Inventors: Peter Kazazes, Palm Beach Gardens, FL (US); Ming-Yuan Lu, Jersey City, NJ (US)

(21) Appl. No.: 18/881,031

(22) PCT Filed: Jul. 6, 2023
(86) PCT No.: PCT/US2023/027005

§ 371 Date: Jan. 3, 2025

Related U.S. Application Data
(60) Provisional application No. 63/358,666, filed on Jul. 6, 2022.

(51) Int. Cl. G06T 11/00

(52) U.S. Cl. CPC G06T 11/00; G06T 2210/21

(57) ABSTRACT

A system for exploring unidentified aerial phenomena (UAP) includes a processor and a memory. The memory includes instructions stored thereon, which, when executed by the processor, cause the system to: access a UAP dataset comprising reported information regarding a UAP; generate, based on the UAP dataset, a metric for a confidence that a UAP was at a first location during a period of time; and display a graphical representation of the metric for the confidence that the UAP was at the first location during the period of time. The metric for the confidence includes an indication of a presence or an absence of the UAP at the period of time.

### CROSS REFERENCE TO RELATED APPLICATION

The present application claims the benefit of and priority to U.S. Provisional Application No. 63/358,666, filed on Jul. 6, 2022. The entire contents of the foregoing applications are incorporated by reference herein.

### TECHNICAL FIELD

The present disclosure relates generally to the field of unidentified aerial phenomena and, more specifically, to the analysis of unidentified aerial phenomena.

### BACKGROUND

Unidentified aerial phenomena (UAP) are any perceived aerial phenomena that cannot be immediately identified or explained. While unusual sightings have been reported in the sky throughout history, UAPs did not achieve their current cultural prominence until after World War II. There is interest in exploring unidentified aerial phenomena both among the public and, more recently, the U.S. Congress, which has formally directed the creation of a new government office to investigate.

### SUMMARY

An aspect of the present disclosure provides a system for exploring historical unidentified aerial phenomena (UAP) datasets. The system includes a processor and a memory. The memory including instructions stored thereon, which, when executed by the processor, cause the system to: access a UAP dataset comprising reported information regarding a UAP; generate, based on the UAP dataset, a metric for a confidence that a UAP was at a first location during a period of time, wherein the metric for the confidence includes an indication of a presence or an absence of the UAP at the period of time; and display a graphical representation of the metric for the confidence that the UAP was at the first location during the period of time.

In an aspect of the present disclosure, the UAP dataset may include a plurality of historical UAP events.

In another aspect of the present disclosure, the UAP dataset may include a plurality of historical UAP events.

In yet another aspect of the present disclosure, the instructions, when executed, by the processor, may further cause the system to determine an approximate ground shadow of the UAP based on at least one of a reported speed or a reported altitude of the UAP, the reported speed or the reported altitude of the UAP stored in the UAP dataset.

In a further aspect of the present disclosure, the reported speed and the reported altitude may be determined based on at least one of video, radar, lidar, or sonar.

In yet a further aspect of the present disclosure, the instructions, when executed by the processor, may further cause the system to generate an augmented reality (AR) overlay based on the UAP location.

In a further aspect of the present disclosure, the AR overlay may further include a satellite image overlay.

In yet a further aspect of the present disclosure, the location may be accessed by a selection by a user, a user device geospatial location, and/or a recommendation engine.

In an aspect of the present disclosure, the instructions, when executed by the processor, may further cause the system to: access an image, the image including the UAP. The image includes metadata relating to the image. The metric may be further determined based on the metadata.

An aspect of the present disclosure provides a system for exploring unidentified aerial phenomena (UAP). The system includes a processor and a memory. The memory includes instructions stored thereon, which, when executed by the processor, cause the system to: determine a first virtual viewpoint of a first user device at a first location, wherein the first virtual viewpoint includes a UAP; determine a second virtual viewpoint of a second user device at a second location different from the first location, wherein the second virtual viewpoint includes the UAP; determine a third virtual viewpoint of a third user device at a third location different from the first and second locations, wherein the third virtual viewpoint includes the UAP; determine a zone of intersection between the first, second, and third virtual viewpoints; and display, in an augmented reality view, a virtual pointer indicating the zone of intersection, indicating a geospatial location of the UAP.

An aspect of the present disclosure provides a computer-implemented method for exploring unidentified aerial phenomena (UAP). The computer-implemented method includes: accessing a UAP dataset comprising reported information regarding a UAP; and generating, based on the UAP dataset, a metric for a confidence that a UAP was at a first location during a period of time. The metric for the confidence includes an indication of a presence or an absence of the UAP at the period of time. The method further includes displaying a graphical representation of the metric for the confidence that the UAP was at the first location during the period of time.

In an aspect of the present disclosure, the UAP dataset may include a plurality of historical UAP events.

In another aspect of the present disclosure, the historical UAP events each may include a time stamp and a geospatial location.

In yet another aspect of the present disclosure, the method may further include determining an approximate ground shadow of the UAP based on at least one of a reported speed or a reported altitude of the UAP, the reported speed or the reported altitude of the UAP stored in the UAP dataset.

In a further aspect of the present disclosure, the reported speed and the reported altitude may be determined based on at least one of video, radar, lidar, and/or sonar.

In yet a further aspect of the present disclosure, the method may further include generating an augmented reality (AR) overlay based on the first location.

In an aspect of the present disclosure, the AR overlay may further include a satellite overlay.

In another aspect of the present disclosure, the first location may be accessed by a selection by a user, a user device geospatial location, and/or a recommendation engine.

In yet another aspect of the present disclosure, the method may further include accessing an image, the image including the UAP. The image may include metadata relating to the image. The metric may be further determined based on the metadata.

In a further aspect of the present disclosure, the metric may be further based on at least one of a number of witnesses, a duration, reporting delay, media, sunlight conditions, behavioral pattern, environmental conditions, sensor, UAP size, UAP distance, or UAP shape.

Further details and aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a block diagram of a system for exploring historical UAP datasets, in accordance with aspects of the disclosure;

FIGS. 2A-I are larger displays of the individual components of the block diagram outlined in FIG. 1, in accordance with aspects of the disclosure;

FIG. 3 is a block diagram of a controller configured for use with the system of FIG. 1, in accordance with aspects of the disclosure;

FIG. 4 illustrates a launch screen of the system of FIG. 1, in accordance with aspects of the disclosure;

FIGS. 5A-W illustrate a map, a globe, and a data page, in accordance with aspects of the disclosure;

FIGS. 6A-D illustrate a directory and message page, in accordance with aspects of the disclosure;

FIGS. 7A-F illustrate a community page, in accordance with aspects of the disclosure;

FIGS. 8A-B are individual displays of the library page, in accordance with aspects of the disclosure;

FIGS. 9A-B illustrate a profile page, in accordance with aspects of the disclosure; and

FIG. 10 is a flow diagram for a computer-implemented method for exploring historical unidentified aerial phenomena datasets, in accordance with aspects of the disclosure.

### DETAILED DESCRIPTION

The present disclosure relates generally to the field of unidentified aerial phenomena (UAP). More specifically, an aspect of the present disclosure provides systems and methods for exploring historical unidentified aerial phenomena datasets.

Aspects of the present disclosure are described in detail with reference to the drawings, wherein like reference numerals identify similar or identical elements.

Although the present disclosure will be described in terms of specific aspects and examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

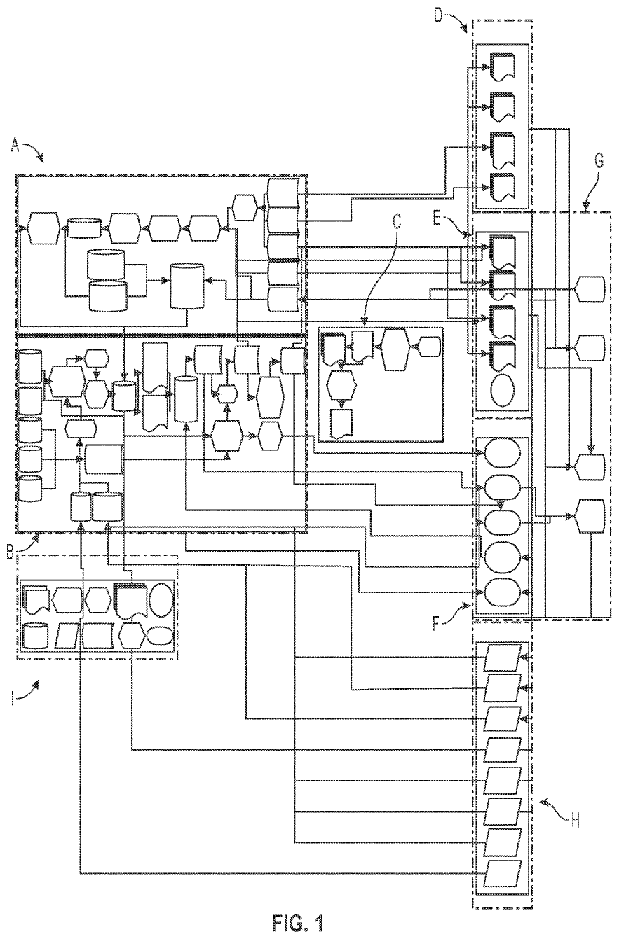

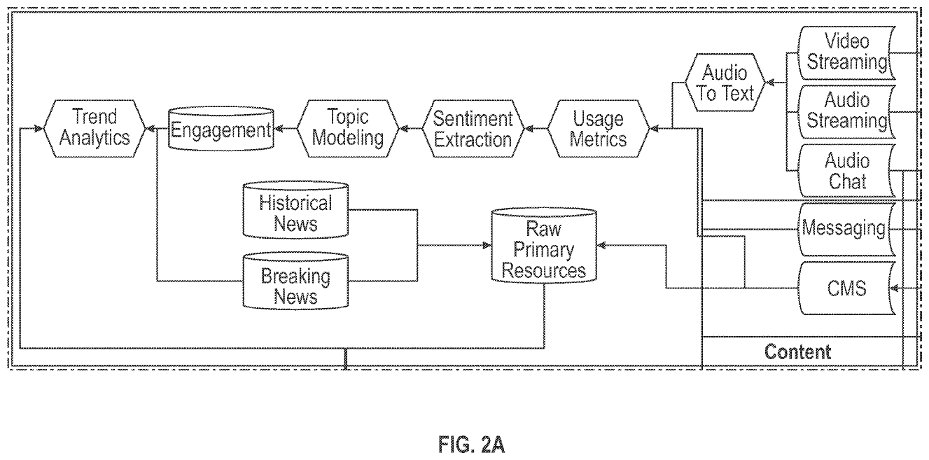

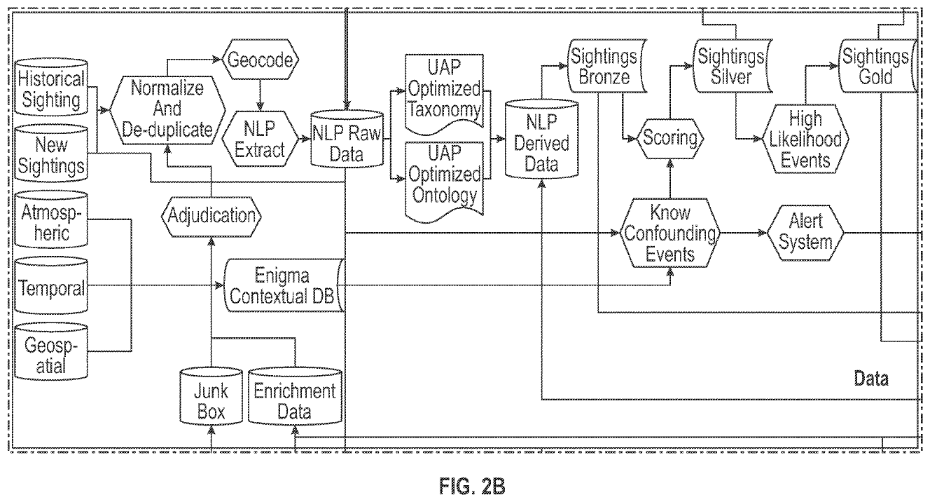

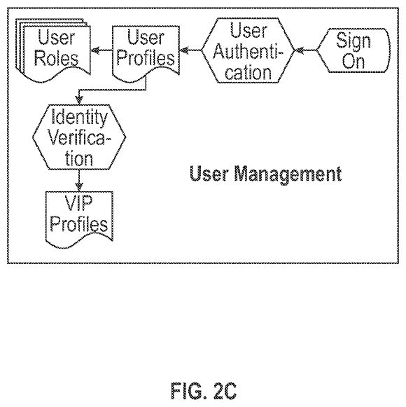

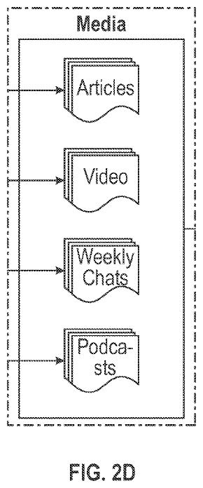

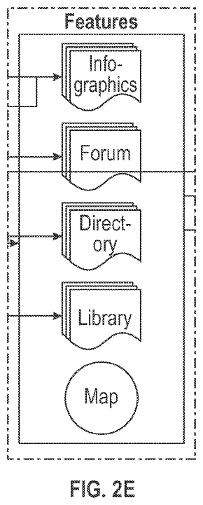

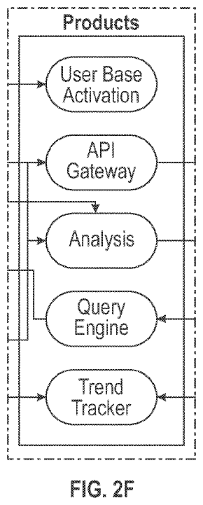

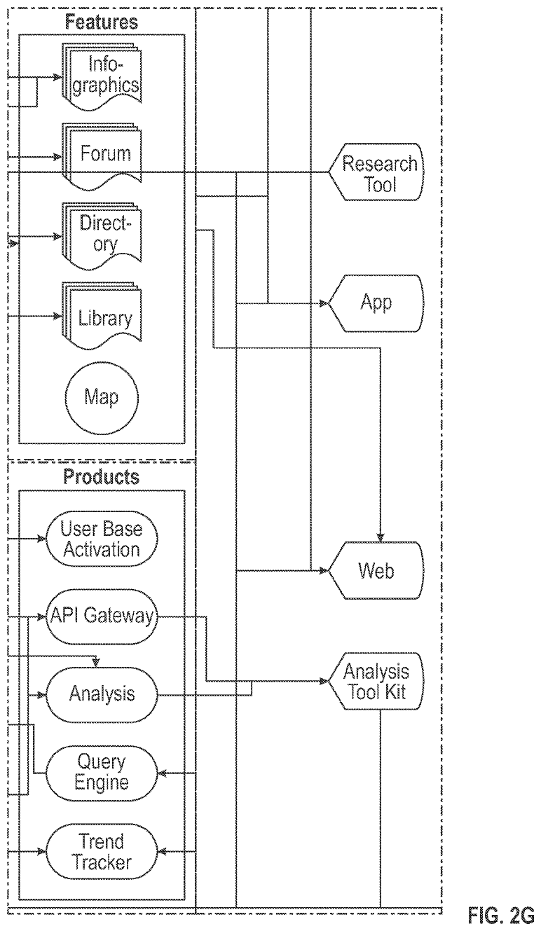

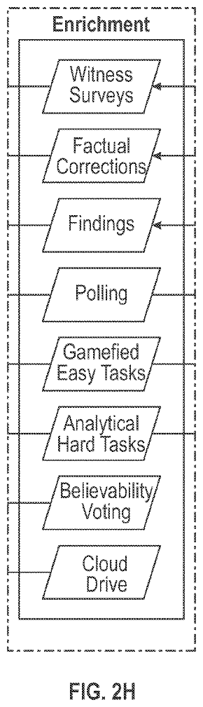

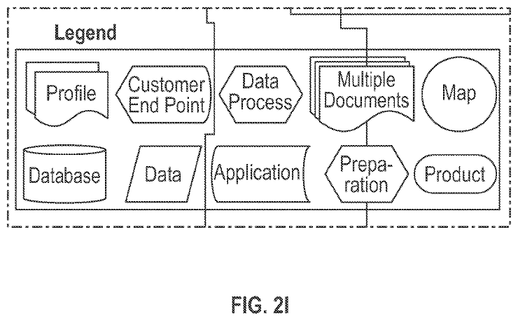

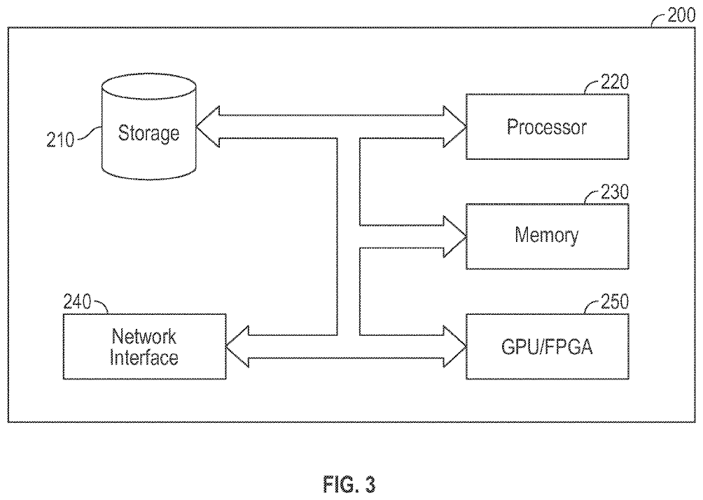

Referring to FIGS. 1 and 2A-2I, block diagrams of aspects of a system for exploring historical UAP datasets are shown. The illustrated blocks may perform the functionality shown by the labels in the blocks. The system 200 (FIG. 3) may operate on a mobile device, a user device, and/or on a remote device such as a remote server or cloud device.

FIG. 2B describes a method to cleanse UAP data, which may include normalizing data onto a graphical database enriched by machine learning, comparing the graphical database with known geospatial, atmospheric, and/or temporal variables, and scoring (i.e., determining a metric) the UAP data events based on relevancy, credibility, unidentifiability, and/or believability.

In aspects, the believability score may be based on a number of witnesses and supporting media. Believability scores may be ranked as “Bronze Sighting,” “Silver Sighting,” and/or “Gold Sighting.” Bronze Sighting includes events verified in the database, Silver Sighting includes events pending verification in the database, and Gold Sighting includes unverified events with a high believability score. In aspects, the believability score may be further determined by the subjective believability given by the community.

For example, the metric=the relevance score*the credibility score*the unidentifiability score. The scores may range, for example, between 0 to 1.

In aspects, the relevancy score may be based on how significant the event is related to UAPs. Events that include sufficient UAP data may have a high relevancy score, whereas events that include insufficient UAP data may have a low relevancy score. For example, some reports are not related to UAP, but are related to some other phenomenon or issues (e.g., paranormal activities, alien abduction without any mentions of crafts, personal stories, or business matters). For example, a text classification model may be created that includes two classes, e.g., “UAP” and “non-UAP.” The relevance is the class probability of the “UAP” class. The relevance score uses the relevance of an incident survey that has the highest total score as the relevance of the incident. I.e., s denotes the total score for incident surveys contained in an incident, and r is the relevance scores for the incident surveys contained in the incident, the incident's relevance R is R=r(argmax(s)).

In aspects, the unidentifiability score may be based on the existence of confounding variables, such as geospatial, atmospheric, and/or temporal variables. The presence of these variables may make the event more identifiable, thus lowering the unidentifiability score. The unidentifiability score describes to what extent the level at which the reported phenomenon can be identified as a UAP with commonly known confounding variables. The unidentifiability score may be based on the number and types of confounding variables found in the vicinity of the incident. Incident surveys in an incident naturally are in the vicinity of each other and are also close in time. Therefore, it is likely that they share common confounding variables.

In aspects, the credibility score may be based on the aggregate collection of UAP data from corroborating accounts, time of day, supporting media, duration, foot traffic, local population density, and/or witness credibility. Events that have been reviewed by other investigators who have verified the facts and externally calculated credibility may also be considered. The credibility score measures how credible the incident survey is based on the witness account/description of the sighting, which is also how likely it is that the reported phenomenon truly took place. Weights and subscores may be vectors. The credibility score is the dot product of the two vectors, normalized by the sum of the weights to form a weighted mean. Subscores may include, for example, witness, duration, reporting delay, media (e.g., videos and/or photos), sunlight conditions, behavioral pattern, environmental conditions, sensor (e.g., sonar, lidar, FLIR, and/or radar), size, distance, and/or shape. Each of the subscores may be assigned an associated weight. Subscores may scale linearly or exponentially. For example, the media subscore may be configured to scale exponentially.

Regarding the witness subscore, the more witnesses involved, the higher the credibility of the observation of the incident. Similarly, if the witness(es) has a background in aerospace, military, or science, the observation they reported can be considered more credible.

Regarding the duration subscore, a larger duration observation should be considered more credible, while a shorter one would be considered less credible. Regarding the media subscore, different media pieces are weighted by quality coefficients and type-specific coefficients.

Regarding the shape subscore, given our lack of knowledge regarding UAP in general, the shape of the UAP generally does not impact the score. However, there are two exceptions. The first exception is that if the shape of the UAP is unknown/not described/not reported, it is a weaker case compared to observations with a defined shape, which suggests clearer observations. The second exception is that “light” as a shape is less descriptive than a well-defined shape. It also implies the inability of the witness(es) to clearly observe and describe the craft, and the object is more likely to belong to mundane explanations such as airplanes. “Light” shape is the most common shape among the dataset (about 20% among NUFORC data, for example) and, therefore may warrant special consideration and treatment. For example, if the shape is unknown, a score of 0 may be used. If the shape is light, then a score of, for example, 0.2 may be used. If the shape is otherwise, for example, a score of 1 may be used.

FIG. 2F describes application feedback given to a user, including push notifications of events in the user's area and a trend tracker. The push notification prompts the user to point their camera at a location in the sky to generate a multi-angle view of the event to collect various event data (e.g., the exact location, behavioral pattern, and/or velocity). The trend tracker is configured to analyze historical data trends to calculate and/or display the likelihood of UAP appearing in an area.

FIG. 2H describes application feedback received from a user, including editorial corrections, database misclassifications, additional media for existing events on the database, and new media for events not on the database. The system of FIG. 1 may transform the application feedback from the user to generate patterns and/or insights for event data (FIG. 2F) and incorporate application feedback from the user into the believability score of the event (FIG. 2B).

The disclosed technology enables users to explore historical UAP datasets on an interactive map, search, and/or filter UAP reports (i.e., an incident survey) based on various parameters, as well as comment, bookmark, share, and/or suggest edits to the data. Users may report any UAP sighting in real time by uploading videos/images, audio transcribing event details, and/or sharing the report with others. The disclosed technology enables UAP enthusiasts to connect with each other and have ongoing group discussions. The disclosed technology also provides comprehensive UAP research materials, including articles and links to videos and/or podcasts.

The system includes collaborative features, such as an augmented reality (AR) overlay (e.g., a digital laser pointer) and a satellite overlay. The AR overlay enables a user to notify other users in the area to point at the sky to capture the UAP event in real-time and/or on demand. The system may also enable user collaboration regarding UAP trajectory and/or speed estimates using recordings from multiple users. In aspects, the collaborative features may further include planets and/or stars overlaid on the user's device to be distinguished from a UAP. In another aspect, user collaboration may be used to digitally reconstruct object characteristics of the UAP. Object characteristics of the UAP may include the arc, trajectory, speed, size, and/or shape. The satellite overlay is configured to display the positions of satellites in the sky relative to the viewpoint of a user's device's imaging sensor.

The digital laser pointer may enable three or more users to triangulate a UAP. For example, a user may project his virtual view area for other users to see. Two or more other users may intersect their virtual views to help triangulate the position of the UAP in the AR overlay.

The system may review images manually and/or automatically remove personal and/or confidential information.

The system enables the creation of a “trend tracker” and/or “weather report” style prediction of places likely to see UAPs based on historical information. For example, based on historical data the system may display to a user predicted UAP activity in a particular location in Washington state through a standardized incident report structure. The system may generate a metric (i.e., a total score) for determining the probability of seeing a UAP for a particular location.

In aspects, the system 200 may determine a metric based on the confidence that a UAP observation happened at a particular geospatial location.

In aspects, for images (e.g., video or still images) captured using the system 200, the system 200 may store metadata such as white balance, aperture, and/or lighting. The system 200 may use the metadata to enable determining the metric. For example, the metric may be a letter grade, a percentage, and/or other score.

In aspects, the incident report structure may augment secondary environment data, including local plane traffic, local weather conditions, and/or satellite positioning.

In aspects, the system 200 (FIG. 3) may access a UAP dataset. The UAP dataset includes a plurality of historical UAP events. The historical UAP events each include a time stamp and a geospatial location. The UAP dataset may include, for example, sightings, media, binary questions about the sighting, credentialed observer (e.g., Dr, pilot, and/or police officer), and/or sensor capture (radio, sonar).

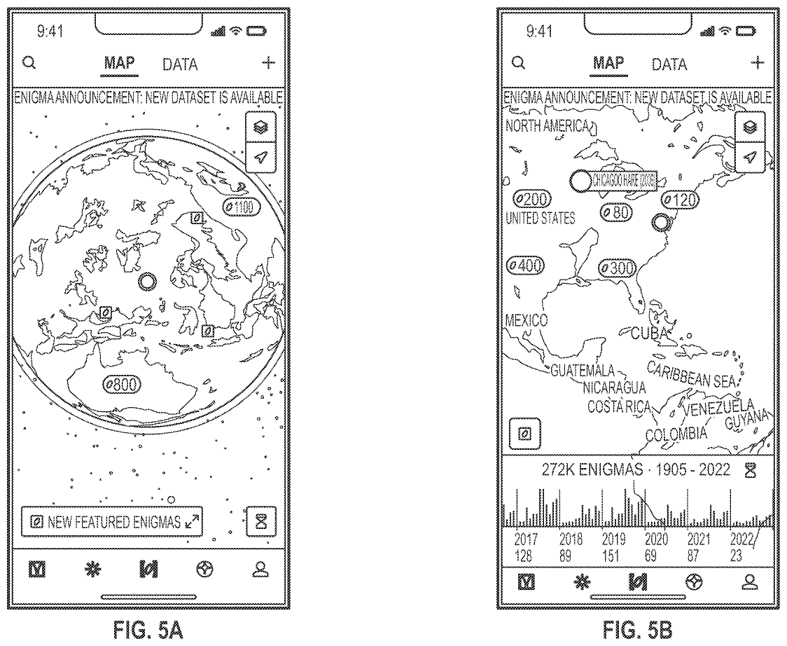

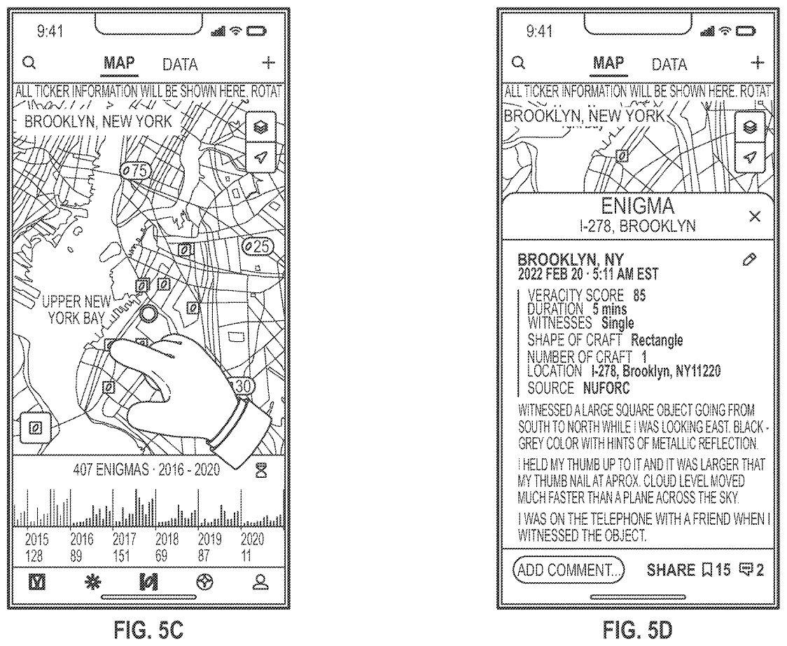

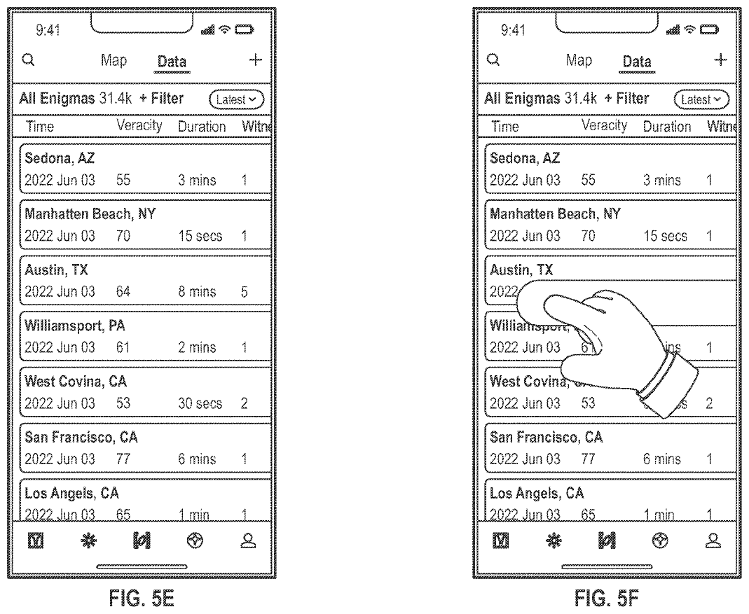

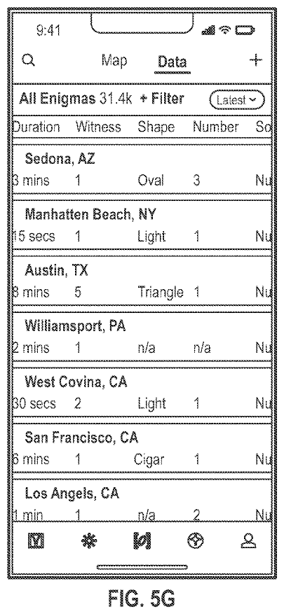

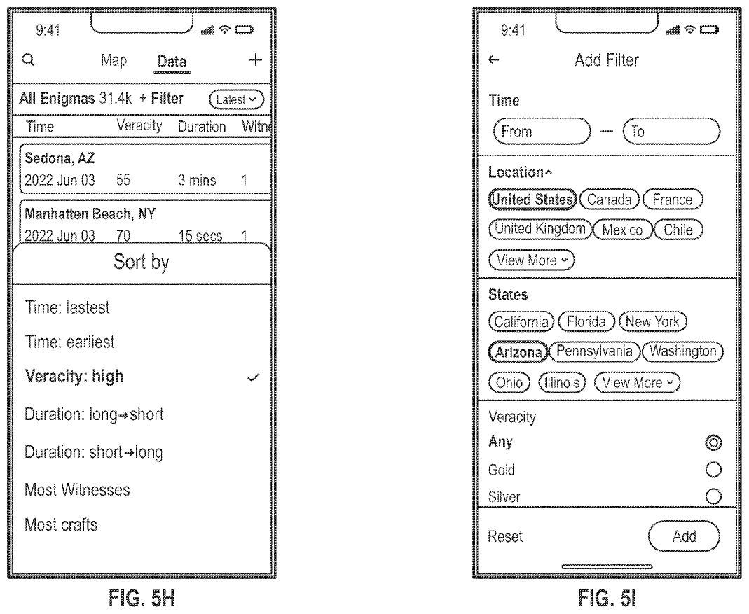

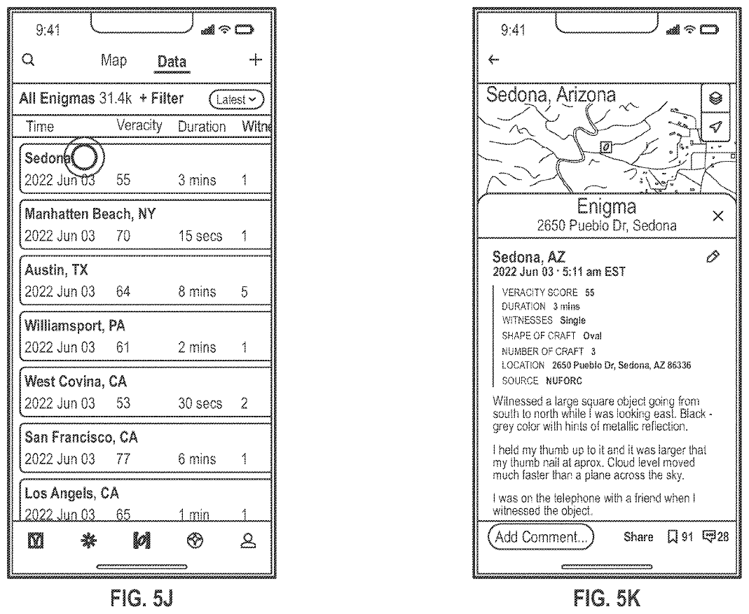

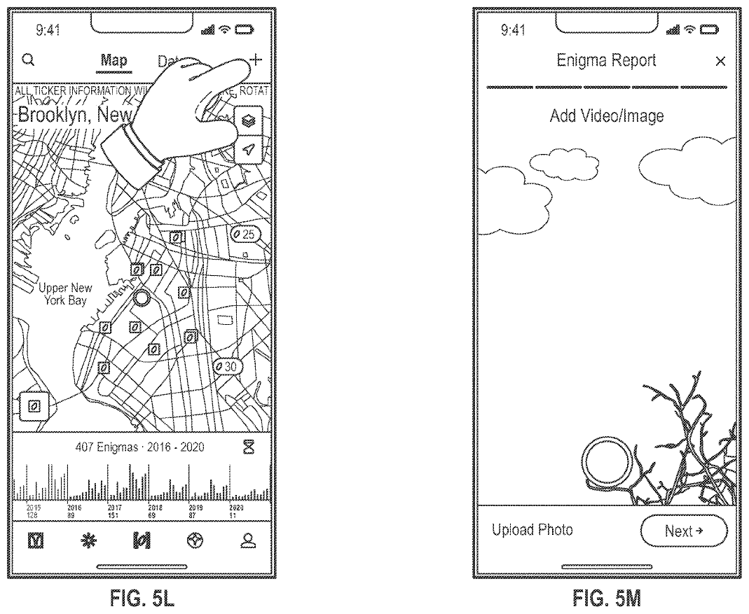

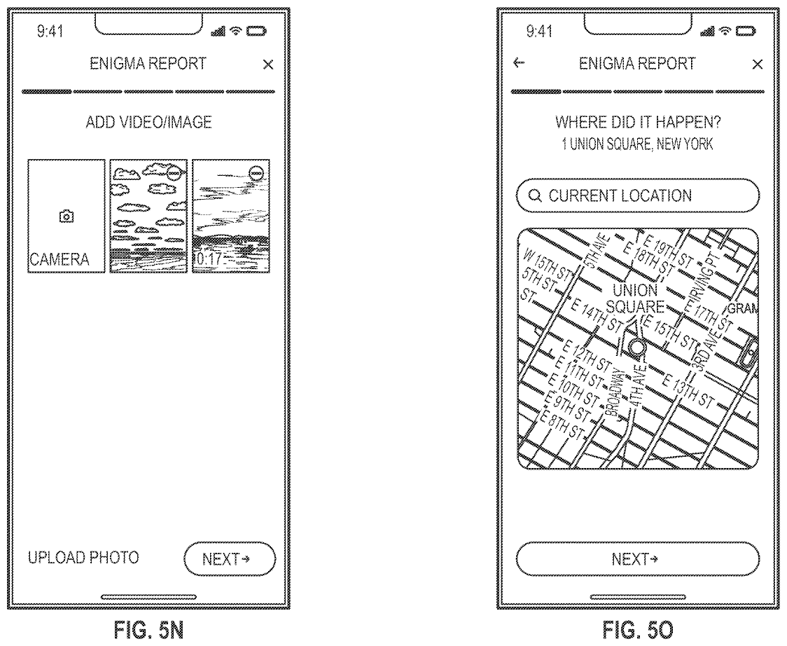

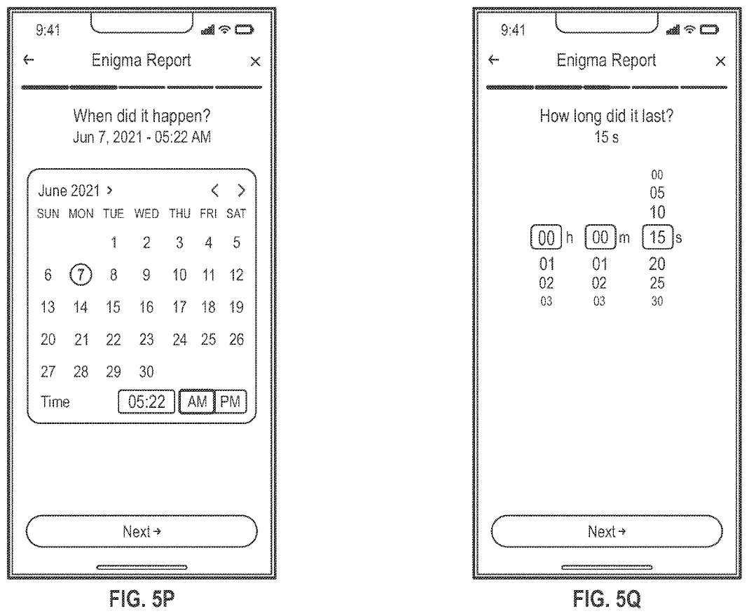

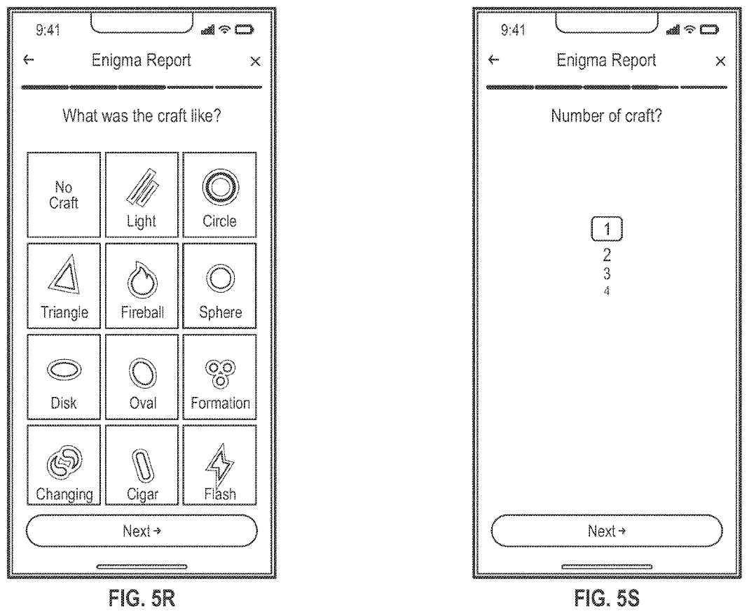

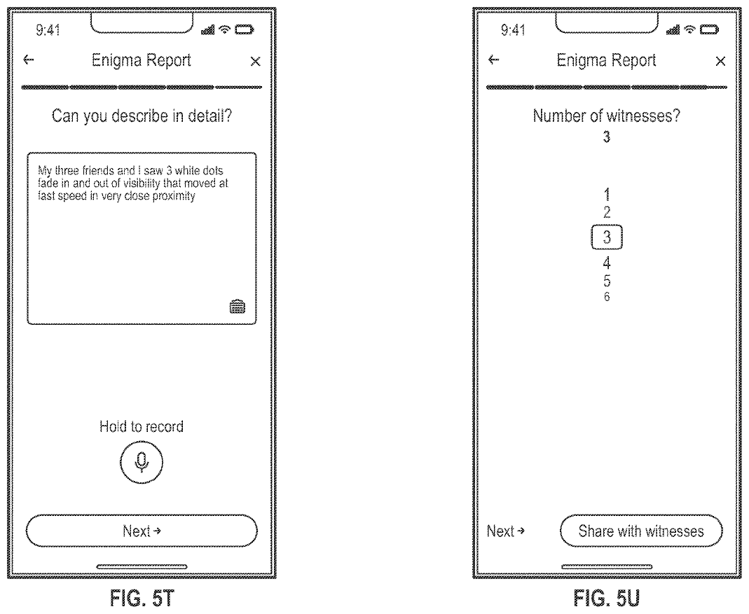

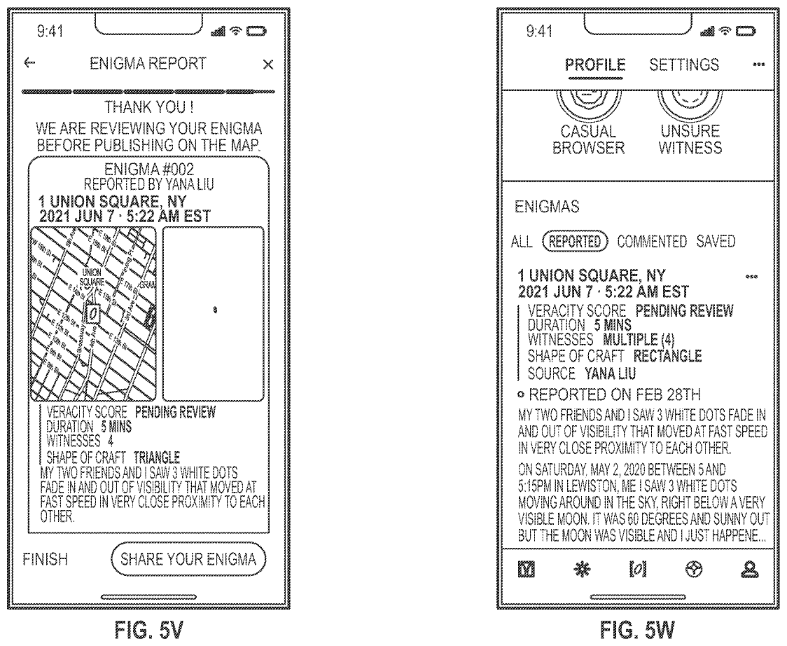

Next, the system 200 may identify a first location, such as the user's current location. The user may enter the location by pointing to a point on the globe page (FIG. 5A). In aspects, the first location may be accessed by at least one of a selection by a user, a user device geospatial location, or a recommendation engine.

The system 200 may generate, based on the dataset, a metric for a confidence that the UAP was at a first location during a period of time. The metric for the confidence includes an indication of the presence or an absence of the UAP at the period of time. For example, the location may be New York City, and the probability for the presence of a UAP may be very low. The system 200 may display a graphical representation of the metric for the probability of the presence or absence of the UAP at the first location. For example, the system 200 may highlight the location in a color such as green, or may provide a total score such as 10%.

In aspects, the system 200 may determine a dynamic radius. For example, the system 200 may determine an approximate ground shadow to determine which user could have seen/captured the UAP based on a speed and/or an altitude of the UAP, during the period of time. The speed and altitude may be determined, for example, using video from a user device or from sensors, such as for example, radar, lidar, and/or sonar.

FIG. 3 illustrates system 200 and includes a processor 220 connected to a computer-readable storage medium or a memory 230. The system 200 may be used to control and/or execute operations of the system. The computer-readable storage medium or memory 230 may be a volatile type of memory, e.g., RAM, or a non-volatile type of memory, e.g., flash media, disk media, etc. In various aspects of the disclosure, the processor 220 may be another type of processor, such as a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the system 200 and can communicate with the processor 220 through communication buses of a circuit board and/or through communication cables such as serial ATA cables or Other types of cables. The memory 230 includes computer-readable instructions that are executable by the processor 220 to operate the system 200. In other aspects of the disclosure, the system 200 may include a network interface 240 to communicate with other computers or to a server. A storage device 210 may be used for storing data. The disclosed method may run on the system 200 or on a user device, including, for example, on a mobile device, an IoT device, or a server system.

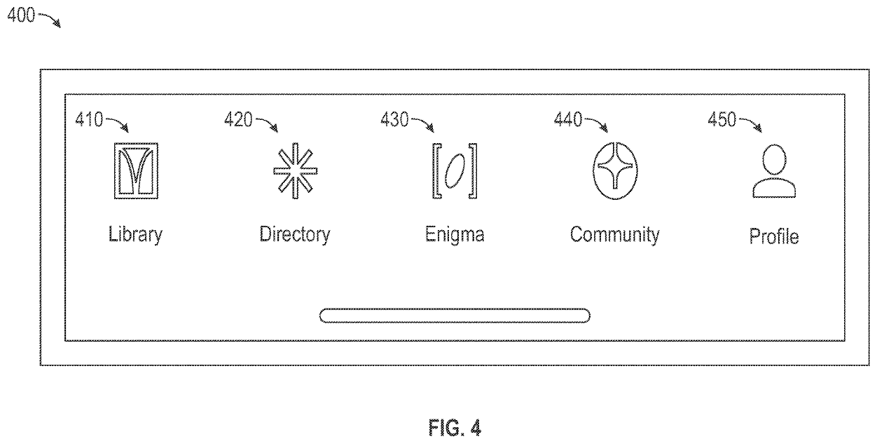

Referring to FIG. 4, a launch screen for the disclosed technology (i.e., the Enigma App) is shown. The launch screen includes five tabs including: Library, Directory, Enigma Map/Data, Community, and Profile. The tabs may be clicked and/or swiped to access the associated screens. FIGS. 5A and 5B show the globe view and map view pages. In the globe view page, when a user returns to the Enigma App, the Enigma App opens the Map with a 3D globe view. The globe may be rotated and/or zoomed to view clustered UAP reports in different regions. In aspects, when zooming in to a definable threshold level, the map is configured to automatically switch from a 3D to a 2D view. In the map view page, when a user explores the map, the user may see clustered UAP reports and highlighted/featured UAP events. The map may provide a togglable timeline as a data filter for users to choose certain years of data for display. The map is configured for zooming and/or panning, while the map will dynamically show the geographical label of the region in view. On the map page, users may have access to search, UAP self-report, and a table view of all Enigma data.

FIGS. 5C and 5D illustrate an Enigma Card page. When tapping any Enigma icon on the map, users will see the Enigma card sliding up from the bottom, overlaying the map. The Enigma Card page shows various data of the event, as well as detailed information. Users may add comments, share, bookmark and suggest edits to the report on this page.

FIGS. 5E-5K show the Data View page. Users may toggle between map view and data view. Data view displays Enigma reports in a structured data table. Users may pan the table to view different data columns.

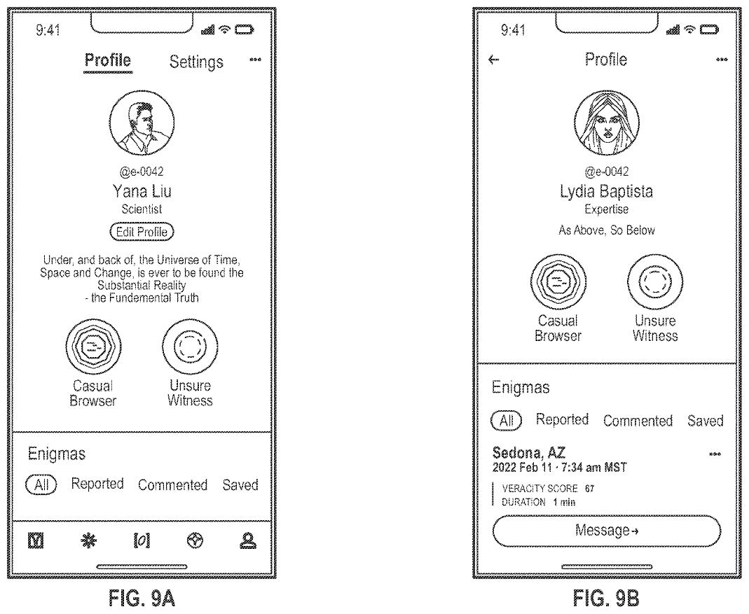

FIGS. 5L-W illustrate a Self-Report UAP Event page. For example, a user may tap the plus (“+”) icon, and report a UAP event by uploading images, videos, location information, time and date information, a description, and other details. Once uploaded, users may share the report to the network and view their reports on their Profile Page (FIGS. 9A and 9B).

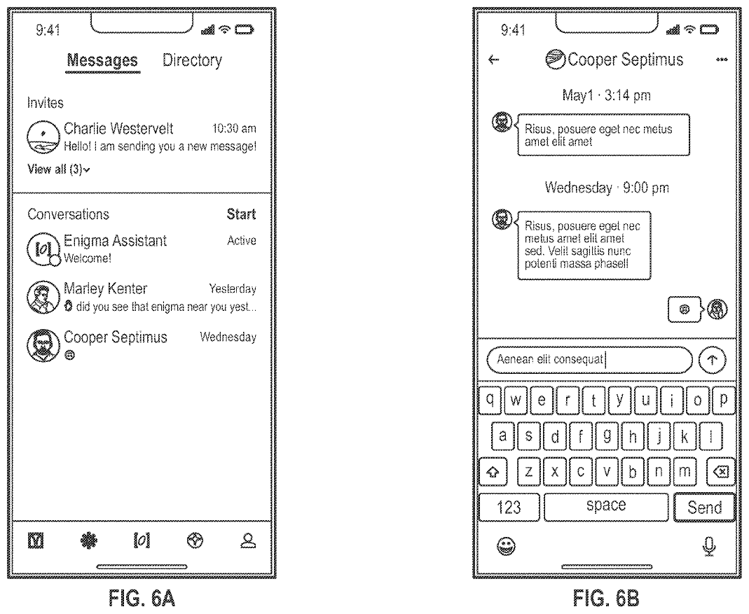

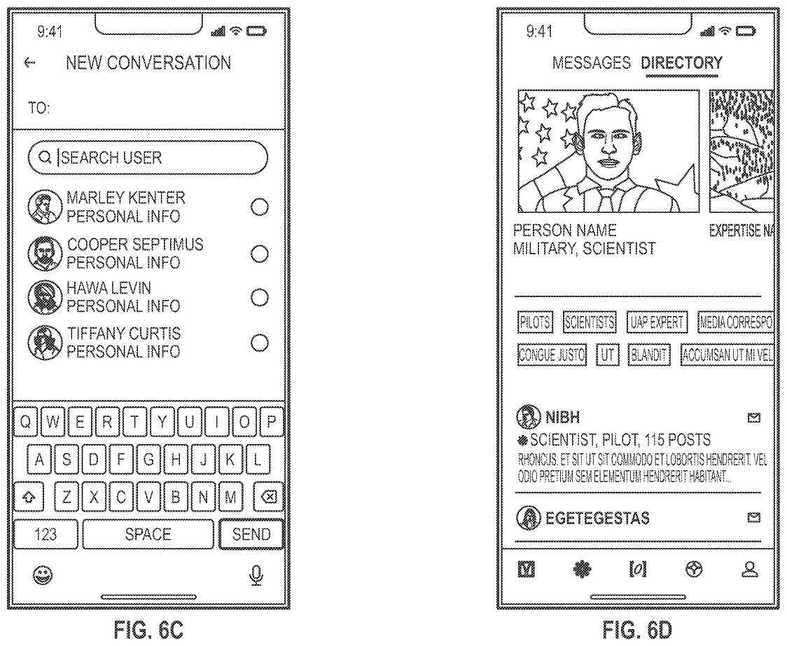

FIGS. 6A-C illustrates the Message Page. In the Message Page, users may send direct messages to other users. In aspects, users may send group messages to more than one user. In other aspects, users may send digital media (e.g., images and/or videos) to one user or a group of users.

FIG. 6D shows the Directory Page. In the Directory Page, users may browse the Enigma App to find popular figures in the UAP community. In aspects, the Directory Page may be used to find any user on the Enigma App.

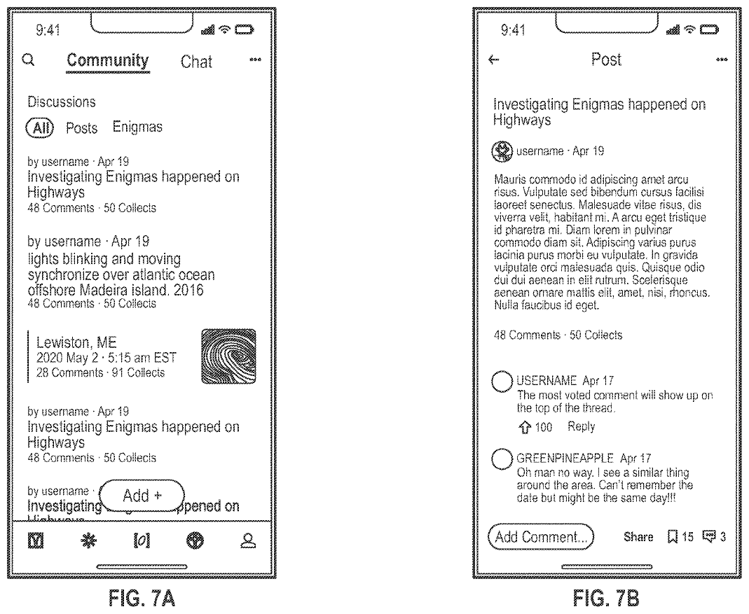

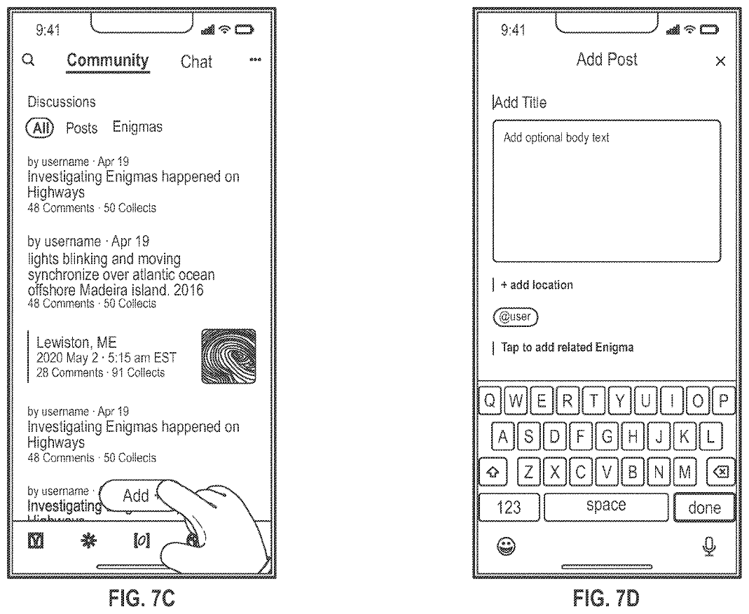

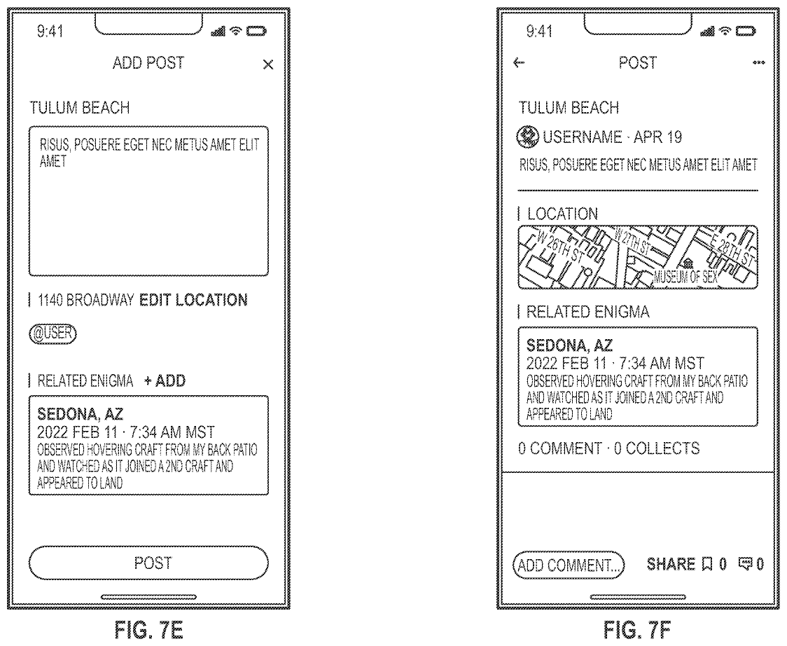

FIGS. 7A and 7B show the Community Page. In the Community Page, users may view reports of UAP events as well as conversations and comments regarding enigmas in general. As used herein, the term enigma includes unexplained and/or unidentified phenomena. Users may comment on reports of UAP events and any conversations or comments regarding other enigmas. FIGS. 7C and 7D illustrate how a user may post articles or comments on to the Community Page. When posting on to the community page, users are prompted to add a title, an optional body of text, and the location of the enigma. A user may also tag other users by including the other user's username on to the post or comment or add their post to an existing post on the Community Page. FIGS. 7E and 7F illustrate examples of completed posts by a user. Upon posting to the Community Page, users will be able to view the title, body of text, location, and existing comments on the post and post their own comments on the post. Users may share the post with others on the application or bookmark the post to save on their Profile Page referenced in FIGS. 9A and 9B. In aspects, users may share the post with others using third-party applications (e.g., a messaging application and/or a social media platform).

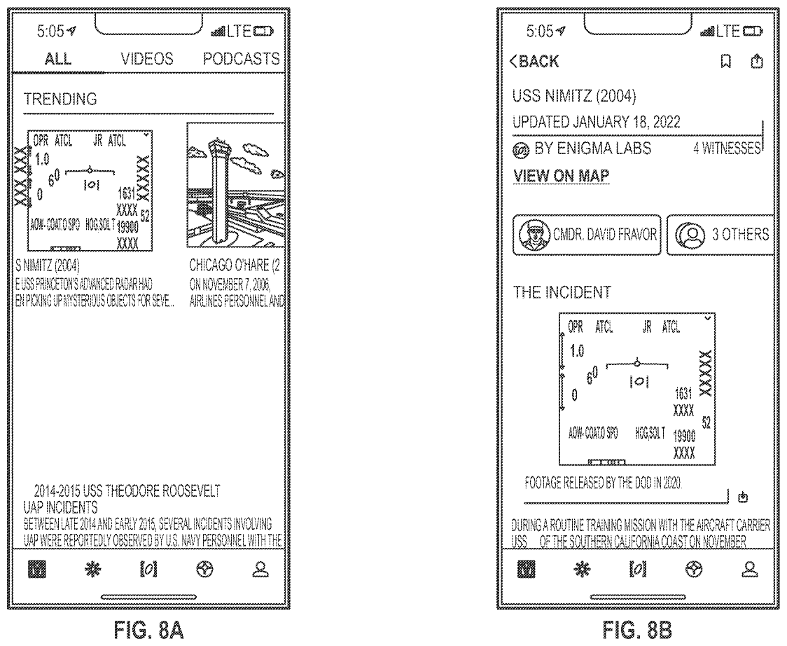

FIGS. 8A and 8B illustrate the Library Page. The page includes articles, videos, and podcasts regarding UAPs, which users may read, watch, and listen to on the application. The user may share the articles, videos, and podcasts with other users or bookmark the desired media to save on their Profile Page referenced in FIGS. 9A and 9B. In aspects, users may share the post with others using third-party applications (e.g., a messaging application and/or social media platform).

FIGS. 9A and 9B illustrate a user's Profile Page. FIG. 9A shows the Profile Page of the user that will appear when tapping the profile icon 450 (FIG. 4). On this page the user may edit attributes of their profile (e.g., their profile picture, title, and/or biography). In aspects, users may edit their username and reported enigmas or delete comments and saved enigmas from their profile. The user may also edit their profile settings (e.g., the user's password, email address, phone number, and/or privacy preferences). FIG. 9B shows the Profile Page of another's profile that will display on the user's screen. When viewing another's profile, the profile picture, username, title, biography, enigmas reported, enigmas commented on, and enigmas saved will be shown. The user may also message the profile being viewed directly on the Profile Page, which will subsequently display the Message Page of FIG. 6B. In aspects, the user will have the option to add the user as their friend to save on the user's friends list.

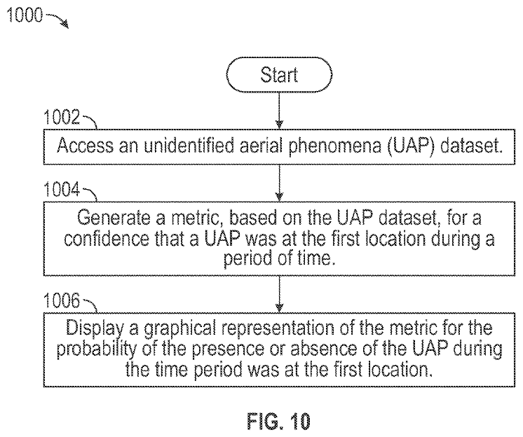

FIG. 10 shows a block diagram for an exemplary method 1000 for exploring unidentified aerial phenomena. Although the steps of FIG. 10 are shown in a particular order, the steps need not all be performed in the specified order, and certain steps can be performed in another order. For example, FIG. 10 will be described below, with a server (e.g., system 200 of FIG. 3) performing the operations. In various aspects, the operations of FIG. 10 may be performed all or in part by the system 200 of FIG. 3. In aspects, the operations of FIG. 10 may be performed all or in part by another device, for example, a mobile device and/or a client computer system. These and other variations are contemplated to be within the scope of the present disclosure.

At step 1002, the system 200 accesses an unidentified aerial phenomena (UAP) dataset. The UAP dataset may be stored locally or stored remotely. The UAP dataset may include a plurality of events, which include, for example, sightings, media, binary questions about the sighting, credentialed observer, and/or sensor capture. The historical UAP events each include a time stamp and a geospatial location. For example, a UAP event may have been reported in the system 200 by a police officer, where the report includes video and LIDAR data related to the UAP.

For example, a user may click on a location on a representation of the globe on a screen associated with the system 200. The location may be associated with an observation of a UAP. In another example, the user may be presented with a prompt based on the user's geospatial location. The prompt may indicate that there was a UAP observation within a radius. In aspects, the system 200 may provide a push notification. The push notification may prompt the user to point their camera at a location in the sky to generate a multi-angle view of the event to collect various event data (e.g., the exact location, behavioral pattern, and/or velocity).

At step 1004, the system 200 generates a metric, based on the UAP dataset, for a confidence that the UAP was at a first location during a period of time. The metric may include an indication of the presence or the absence of the UAP at the period of time.

In aspects, the system 200, may normalize the UAP data onto a graphical database. In aspects, the system 200 may determine a metric for the UAP events based on relevancy, credibility, unidentifiability, and/or believability by comparing the graphical database with known geospatial, atmospheric, and/or temporal variables, and scoring the UAP data events.

At step 1006, the system 200 displays a graphical representation of the metric for the probability of the presence or absence of the UAP during the time period was at the first location.

In aspects, the system 200 may display a graphical representation of the globe indicating places where the probability of the presence of UAP events during the time period is above a threshold value. In aspects, the system 200 may predict the probability of a future Prescence of a UAP based on the metric.

In aspects, the system 200 may determine an approximate ground shadow of the UAP based on at least one of a speed or an altitude of the UAP. The system 200 may display the determined ground shadow of the UAP.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for exploring unidentified aerial phenomena (UAP), the system comprising:
a processor; and
a memory including instructions stored thereon, which, when executed by the processor, cause the system to:
access a UAP dataset comprising reported information regarding a UAP;
generate, based on the UAP dataset, a metric for a confidence that the UAP was at a first location during a period of time, wherein the metric for the confidence includes an indication of a presence or an absence of the UAP at the period of time; and
display a graphical representation of the metric for the confidence that the UAP was at the first location during the period of time.

2. The system of claim 1, wherein the UAP dataset includes a plurality of historical UAP events.

3. The system of claim 2, wherein the historical UAP events each include a time stamp and a geospatial location.

4. The system of claim 1, wherein the instructions, when executed, by the processor, further cause the system to determine an approximate ground shadow of the UAP based on at least one of a reported speed or a reported altitude of the UAP, the reported speed or the reported altitude of the UAP stored in the UAP dataset.

5. The system of claim 4, wherein the reported speed and the reported altitude are determined based on at least one of video, radar, lidar, or sonar of the UAP dataset.

6. The system of claim 1, wherein the instructions, when executed, by the processor, further cause the system to generate an augmented reality (AR) overlay based on the first location.

7. The system of claim 6, wherein the AR overlay further includes a satellite image overlay.

8. The system of claim 1, wherein the first location is identified by at least one of a selection by a user, a user device geospatial location, or a recommendation engine.

9. The system of claim 1, wherein the instructions, when executed, by the processor, further cause the system to:
access an image from the UAP dataset, the image including the UAP,
wherein the image includes metadata relating to the image, and
wherein the metric is further determined based on the metadata.

10. A system for exploring unidentified aerial phenomena (UAP), the system comprising:
a processor; and
a memory including instructions stored thereon, which, when executed by the processor, cause the system to:
determine a first virtual viewpoint of a first user device at a first location, wherein the first virtual viewpoint includes a UAP;
determine a second virtual viewpoint of a second user device at a second location different from the first location, wherein the second virtual viewpoint includes the UAP;
determine a third virtual viewpoint of a third user device at a third location different from the first and second locations, wherein the third virtual viewpoint includes the UAP;
determine a zone of intersection between the first, second, and third virtual viewpoints; and
display, in an augmented reality view, a virtual pointer indicating the zone of intersection, indicating a geospatial location of the UAP.

11. A computer-implemented method for exploring unidentified aerial phenomena (UAP), the computer-implemented method comprising:
accessing a UAP dataset comprising reported information regarding a UAP;
generating, based on the UAP dataset, a metric for a confidence that a UAP was at a first location during a period of time, wherein the metric for the confidence includes an indication of a presence or an absence of the UAP at the period of time; and
displaying a graphical representation of the metric for the confidence that the UAP was at the first location during the period of time.

12. The computer-implemented method of claim 11, wherein the UAP dataset includes a plurality of historical UAP events.

13. The computer-implemented method of claim 12, wherein the historical UAP events each include a time stamp and a geospatial location.

14. The computer-implemented method of claim 11, further comprising determining an approximate ground shadow of the UAP based on at least one of a reported speed or a reported altitude of the UAP, the reported speed or the reported altitude of the UAP stored in the UAP dataset.

15. The computer-implemented method of claim 14, wherein the reported speed and the reported altitude are determined based on at least one of video, radar, lidar, or sonar of the UAP dataset.

16. The computer-implemented method of claim 11, further comprising generating an augmented reality (AR) overlay based on the first location.

17. The computer-implemented method of claim 16, wherein the AR overlay further includes a satellite image overlay.

18. The computer-implemented method of claim 11, wherein the first location is identified by at least one of a selection by a user, a user device geospatial location, or a recommendation engine.

19. The computer-implemented method of claim 11, further comprising:
accessing an image, the image including the UAP,
wherein the image includes metadata relating to the image, and
wherein the metric is further determined based on the metadata.

20. The computer-implemented method of claim 11, wherein the metric is further based on at least one of a number of witnesses, a duration, reporting delay, media, sunlight conditions, behavioral pattern, environmental conditions, sensor, UAP size, UAP distance, or UAP shape.
